(19) United States
(12) Patent Application Publication
(10) Pub. No.: US 2024/0271820 A1
(43) Pub. Date: Aug. 15, 2024

(54) A VENTILATION DUCT RESISTING HIGH TEMPERATURES

(71) Applicant: Climate Recovery Ind AB, KALMAR (SE)

(72) Inventors: Peter WALLIN, KALMAR (SE); Andreas WALLIN, KALMAR (SE); Göran BERNHARDSSON, BÅSTAD (SE)

(21) Appl. No.: 18/695,951

(22) PCT Filed: Oct. 7, 2022
(86) PCT No.: PCT/SE2022/050906

§ 371 Date: Mar. 27, 2024

(30) Foreign Application Priority Data
Oct. 8, 2021 (SE) 2151233-0

(51) Int. Cl. F24F 13/02; B32B 1/08; B32B 5/02; B32B 7/08; B32B 15/14; B32B 15/18; B32B 15/20; B32B 19/02; B32B 19/04; B32B 27/12; B32B 27/32; B32B 37/04; B32B 37/18

(52) U.S. Cl. CPC F24F 13/0263; B32B 1/08; B32B 5/02; B32B 7/08; B32B 15/14; B32B 15/18; B32B 15/20; B32B 19/02; B32B 19/041; B32B 19/045; B32B 27/12; B32B 27/32; B32B 37/04; B32B 37/182; F24F 13/0218; F24F 13/0281; B32B 2262/101; B32B 2305/07; B32B 2307/402; B32B 2307/718; B32B 2307/7376; B32B 2311/24; B32B 2311/30; B32B 2315/14; B32B 2323/04; B32B 2597/00

(57) ABSTRACT

Elongated ventilation duct comprising a fibre layer (2) without any splices and an inner layer (3) surrounding an elongated flow space (4), wherein
the fibre layer comprises mineral fibres and a binder, compressed into a desired duct shape, the fibres having a melting point over 800 degrees Celsius,
the inner layer is a stainless-steel foil having a thickness of 0.01-0.3 mm, facing the flow space.

A method of manufacturing a ventilation duct having a fibre layer (2) and an inner layer (3) of steel foil, wherein a binder solution is sprayed on the fibre layer, whereafter the fibre layer is compressed into a duct shape, having an elongated flow space (4), under heated conditions so that water in the binder solution evaporates, and bringing the inner layer into the flow space of the duct, which inner layer seals the flow space of the duct from the fibre layer.

The present invention concerns elongated ventilation ducts capable of resisting high temperatures for a long period of time.

There are classifications for the possibility of withstanding high temperatures for ducts. The ducts transfers flue gas and must withstand temperatures between 900 and 1000 degrees Celsius for at least half an hour or at least an hour to fulfil a European classification EN1366 according to EI30/60. This will give people time to evacuate a burning building. According to this classification the cross section must be intact, and the outside temperature of the duct must not exceed 140 degrees Celsius in average and not over 180 degrees Celsius in one point.

At the moment steel ducts are arranged in buildings, which thereafter are provided with mineral wool to insulate the ducts. The mineral wool is usually attached by means of chicken wire around the ducts and mineral wool.

The aim of the present invention is to provide an easily handled, lightweight ventilation duct fulfilling at least the classification EN1366 according to EI30/60.

### SUMMARY OF THE INVENTION

According to a first aspect of the invention the aim can be met by means of an elongated ventilation duct comprising a fibre layer without any splices and an inner layer surrounding an elongated flow space. The fibre layer comprises mineral fibres and a binder, compressed into a desired duct shape and the inner layer is a stainless-steel foil having a thickness of 0.01-0.3 mm, facing the flow space. The mineral fibres should have a melting point over 800 degrees Celsius.

By means of the present invention a low weight and fire resisting elongated ventilation duct is provided in one piece. This means that the elongated ventilation duct is ready for transport to a building site and to be arranged in the building. There will not be necessary for other transports of insulating material and chicken wire. Neither the extra workload to attach the insulating material at the ducts when they are arranged in the building is needed. Thus, it is faster and easier to arrange the ducts according to the invention. Additionally, the ventilation duct of the invention is sound dampening, which means that any vibrations in the duct will not transfer to adjacent building structures due to its semisoft formation. Due to its semisoft formation, it is also a bit flexible so that it can squeeze through tight passages. The duct also comprises a minimum of heat-conducting material and a minimum of energy. The stainless-steel foil helps the duct to withstand high temperatures and protects from corroding.

According to some embodiments an outer layer is provided on the outside of the fibre layer. The outer layer comprises an aluminium foil and a polyethene layer for attachment to the fibre layer. This make the ducts easier and safer to handle since the fibres are encapsuled inside the outer layer.

According to some embodiments the fibre layer is self-supported.

According to some embodiments the mineral fibre length is at least 10 mm, preferably at least 20 mm or at least 30 mm. Due to the long fibres the compressed fibre layer will stay intact also after the binder is burnt out.

According to some embodiments the binder is phenolic based and water soluble.

According to some embodiments the amount of binder in the fibre layer is 1-5% by weight before the compression.

According to some embodiments the elongated ventilation duct lacks binding material between the fibre layer and the inner layer. This keeps the energy level low in the ventilation duct, which keeps the temperature down in the duct.

According to some embodiments the outer layer is black. Thus, heat will dissipate easily.

According to some embodiments the amount of polyethene is between 10-50 g/m², preferably 15-30 g/m².

According to some embodiments the cross-sectional shape is more or less circular.

According to some embodiments stiffening means are present at the inner layer, to provide support for the inner layer to withstand under pressure.

According to a second aspect of the invention a method of manufacturing a ventilation duct having a mineral fibre layer without any splices and an inner layer of stainless-steel foil is provided. A binder solution is sprayed on the fibre layer, whereafter the fibre layer is compressed into a duct shape, having an elongated flow space, under heated conditions so that water in the binder solution evaporates. Thereafter the inner layer is brought into the flow space of the duct, which inner layer seals the flow space of the duct from the fibre layer.

According to some embodiments an outer layer, comprising an aluminium foil and a polyethene layer, is provided on the outside of the fibre layer and heated so that the polyethene foil melts and thus bonds the outer layer to the fibre layer.

According to some embodiments the inner layer has a thickness of 0.01-0.3 mm.

According to some embodiments the inner layer is made up of two elongated sheets of stainless-steel foil, which are united along each long side and raised into a corresponding shape as the flow space of the duct. Preferably, the stainless-steel foils are united by means welding, riveting, or folding.

According to some embodiments the inner layer is drawn more or less linearly along a thought length axis into the flow space of the duct.

According to some embodiments stiffening means are provided at the inner layer.

### SHORT DESCRIPTION OF THE DRAWINGS

The present invention will be described in more detail under referral to the drawings, in which

FIG. 1 shows an elongated duct according to an embodiment of the invention in a perspective view.

FIG. 2 shows a cross-sectional view of another embodiment.

FIG. 3 shows a close-up section view showing ingoing layers of an embodiment in more detail.

FIG. 4 shows an inner layer of an embodiment during manufacture in a perspective view.

FIG. 5 shows an embodiment of stiffening means arranged inside a duct in cut-away view.

FIG. 6 shows another embodiment of stiffening means arranged inside a duct in cut-away view.

### DETAILED DESCRIPTION OF EMBODIMENTS OF THE INVENTION

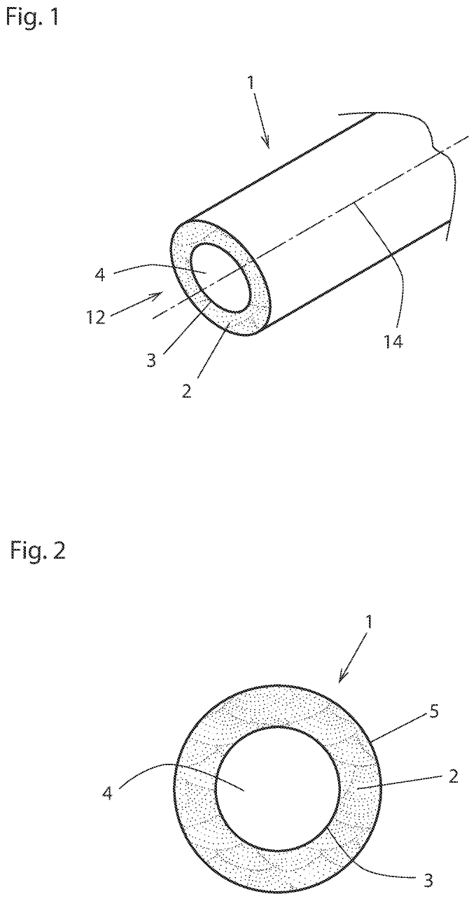

In FIG. 1 an embodiment of an elongated ventilation duct 1 comprising a fibre layer 2 and an inner layer 3 surrounding an elongated flow space 4 is shown in perspective. As is evident from the figures, especially FIGS. 1 and 2, and the description below, the fibre layer is without any splices. The cross-sectional shape may be any suitable shape. In the shown embodiment the elongated ventilation duct 1 has a circular shape. A thought length axis 14 is going through the flow space 4 along the length of the elongated ventilation duct 1 and it has two open ends 12.

The fibre layer 2 is built up by mineral fibres being compressed with a binder. The mineral fibres should have a melting point over 800 degrees Celsius. The fibres may have a length of at least 10 mm, preferably at least 20 mm or at least or 30 mm. In one embodiment the fibre fulfils the classification RAL/40.

The mineral fibres are sprayed with a binder solution, which preferably is based on a water-soluble phenolic resin. Thereafter the mineral fibres are compressed and heated in a form to reach its final shape. During the compression and heating the water in the binder solution evaporates and the phenolic resin cures at a temperature around 200 degrees Celsius. The amount of binder solution before the forming procedure, i.e., the compression and heating, is between 1-5% by weight. The amount of binder is kept to a minimum in order to avoid adding too much energy into the ventilation duct, which energy would increase the temperature in case of fire. It is also conceivable to use other binders than phenolic based.

After the compression and heating step of the fibre layer, the fibre layer is stiff enough to be self-supported so the elongated ventilation is self-supported.

The inner layer is a stainless-steel foil having a thickness of 0.01-0.3 mm, preferably 0.01-0.2 mm and most preferred 0.03-0.1. As an example, AISI 304 may be a suitable steel.

In FIG. 2 another embodiment is shown in a cross-sectional view. According to this embodiment the elongated ventilation duct 1 comprises a fibre layer 2, an inner layer 3 and an outer layer 5. The outer layer 5 comprises at least an aluminium foil and a layer of polyethene. The amount of aluminium may be 15-25 gram/m². The amount of polyethene may be 10-50 g/m², preferably 15-30 g/m².

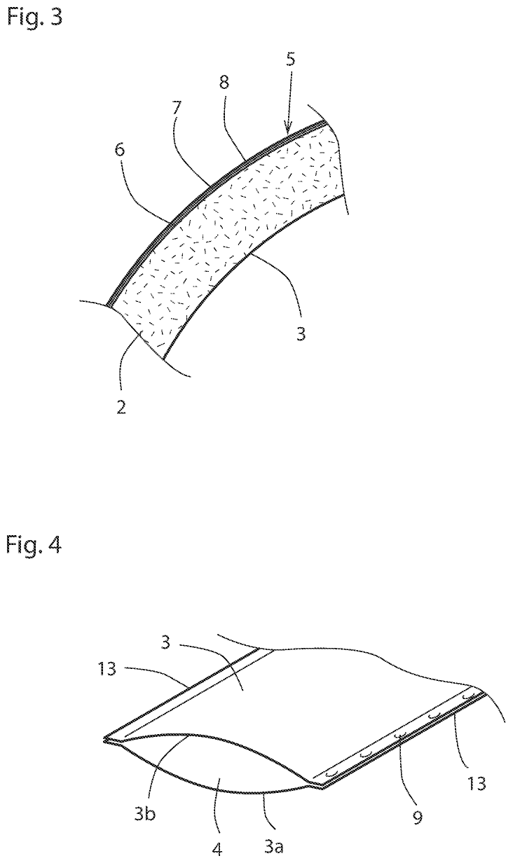

In FIG. 3 a section of an embodiment of an elongated ventilation duct 1 is shown. In this embodiment the duct is built up by an inner layer 3, a fibre layer 2 and an outer layer 5. The outer layer 5 comprises a layer of polyethene 6 closest to the fibre layer 2. The polyethene layer 6 functions as a binder and will stick to the fibre layer 2 by a heating step during production where the polyethene melts and thus bonds the outer layer 5 to the fibre layer 2. Outermost is a layer of aluminium 8 provided. In between a mesh, net or spread glass fibres 7 is provided. The layer of glass fibres 7 increases the strength of the outer layer 5. Preferably, the aluminium 8 is black on its outside, which promote heat dissipation. Generally, the outer layer 5 is arranged to enhance the look of the ventilation duct and to encapsule the fibre, which increases health standards when working with the ducts and the possibility to keep clean.

Under referral to FIG. 4 the production of the inner layer can be described. Preferably, two sheets of stainless-steel foil 3a, 3b are provided one on top of the other. Along long side edges 13 the steel foils are joined by means of welding, such as seam or spot welding 9, or riveting 9. It is also possible to unite by means of folding. If needed it is possible to provide sealing material in the joint between the two steel foils 3a, 3b. This could for example be expandable fire acrylic sealing material.

After uniting the two steel foils 3a, 3b they are raised, for example by means of suction on opposite outer sides of the steel foils 3a, 3b under a movement away from each other, so that a flow space 4 is formed.

The inner layer 3, for example provided according to above, is drawn into a self-supported fibre layer 2, provided with an outer layer 5 or not. Preferably, the two joints between the two steel foils 3a, 3b cut a short distance into the fibre layer 2. When drawn into place the inner layer 3 may be finally shaped into the shape of an inner space of the fibre layer 2, for example by pressing mandrel a having a shape corresponding to the inner space of the fibre layer 2 along the length of the elongated ventilation duct.

Preferably, there is no binding material between the fibre layer 2 and the inner layer 3. In this way the total energy content of the elongated ventilation duct can be kept low. However, an inorganic adhesive is conceivable to fix the inner layer 3 against the inner side of the fibre layer 2.

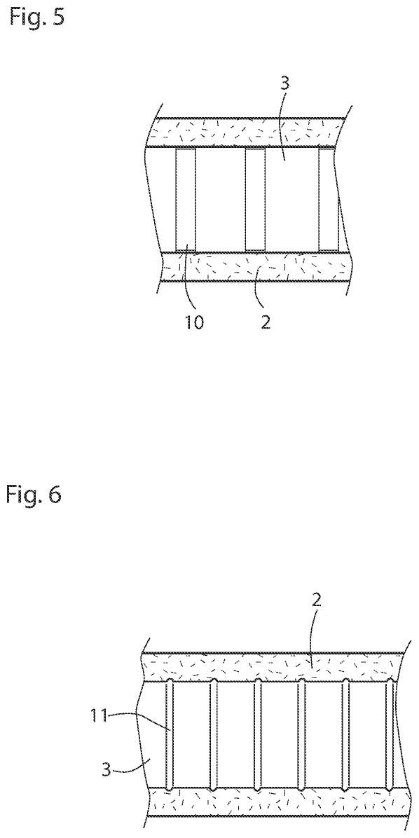

In case of no binding material between the fibre layer 2 and the inner layer 3, it is advantageous to have stiffening means at the inner layer 2 in order to safeguard against the inner layer 3 collapsing during severe under pressure. This could be achieved, for example, according to what is shown FIG. 5, where bands 10 of sheet metal are provided on the inner side, facing the flow space 4, of the inner layer 3 at a distance to each other and more or less transversely to and along the length of the elongated ventilation duct 1.

Another example of how to provide stiffening means is shown in FIG. 6. Here the inner layer 3 itself is provided with stiffening means, in the form of stiffening grooves 11. In the shown embodiment the grooves 11 are more or less transversally oriented but the grooves 11 may be provided in any kind of way giving a stiffening to the inner layer 3.

1. An elongated ventilation duct (1) comprising a fibre layer (2) without any splices and an inner layer (3) surrounding an elongated flow space (4), wherein
the fibre layer (2) comprises mineral fibres and a binder, compressed into a desired duct shape, the mineral fibres having a melting point over 800 degrees Celsius, and
the inner layer (3) is a stainless-steel foil having a thickness of 0.01-0.3 mm, facing the flow space (4).

2. The ventilation duct according to claim 1, wherein an outer layer (5) is provided on the outside of the fibre layer (2), the outer layer comprises an aluminium foil (8) and a polyethene layer (6) for attachment to the fibre layer.

3. The ventilation duct according to claim 1, wherein the fibre (2) layer is self-supported.

4. The ventilation duct according to claim 1, wherein the mineral fibre length is at least 10 mm, preferably at least 20 mm.

5. The ventilation duct according to claim 1, wherein the binder is phenolic based and water soluble.

6. The ventilation duct according to claim 1, wherein the ventilation duct (1) lacks binding material between the fibre layer (2) and the inner layer (3).

7. The ventilation duct according to claim 2, wherein the outer layer (5) is black.

8. The ventilation duct according to claim 2, wherein the amount of polyethene is between 10-50 g/m², preferably 15-30 g/m².

9. The ventilation duct according to claim 1, wherein the cross-sectional shape is more or less circular.

10. The ventilation duct according to claim 6, wherein stiffening means (10, 11) are present at the inner layer.

11. A method of manufacturing a ventilation duct (1) having a mineral fibre layer (2) without any splices and an inner layer (3) of stainless-steel foil, wherein a binder solution is sprayed on the mineral fibre layer (2), whereafter the mineral fibre layer (2) is compressed into a duct shape, having an elongated flow space (4), under heated conditions so that water in the binder solution evaporates, and bringing the inner layer (3) into the flow space of the duct, which inner layer (3) seals the flow space (4) of the duct from the mineral fibre layer (2).

12. The method according to claim 11, wherein an outer layer (5), comprising an aluminium foil (8) and a polyethene layer (6), is provided on the outside of the mineral fibre layer (2) and heated so that the polyethene foil (6) melts and thus bonds the outer layer to the mineral fibre layer (2).

13. The method according to claim 11, wherein the inner layer (3) has a thickness of 0.01-0.3 mm.

14. The method according to claim 11, wherein the inner layer (3) is made up of two elongated sheets of stainless-steel foil (3a, 3b), which are united along each long side (13) and raised into a corresponding shape as the flow space (4) of the elongated ventilation duct (1).

15. The method according to claim 14, wherein the stainless-steel foils (3a, 3b) are united by means welding, riveting or folding.

16. The method according to claim 11, wherein the inner layer (3) is drawn more or less linearly along a thought length axis (14) into the flow space (4) of the elongated ventilation duct (1).

17. The method according to claim 11, wherein stiffening means (10, 11) are provided at the inner layer (3).
